(19) United States
(12) Patent Application Publication
(10) Pub. No.: US 2009/0265227 A1
(43) Pub. Date: Oct. 22, 2009

(54) Methods for Advertisement Display Policy Exploration

(75) Inventors: John Langford, White Plains, NY (US); Tong Zhang, Tuckahoe, NY (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 12/104,423

(22) Filed: Apr. 16, 2008

(51) Int. Cl. G06Q 30/00; G06Q 40/00; G06F 17/10

(52) U.S. Cl. 705/14; 705/35; 705/37; 701/300

(57) ABSTRACT

An exploratory ordering of advertisements is generated using an exploration policy that is a modified version of an existing policy. The exploration policy is defined to swap a pair of adjacent advertisements in an ordering of advertisements generated by the existing policy so to generate the exploratory ordering of advertisements. A top number of the exploratory ordering of advertisements are displayed. The top number corresponds to a number of available advertisement display spaces. Click data associated with display of the exploratory ordering of advertisements is collected. A revenue generation capability of a new policy is evaluated based on the collected click data.

### BACKGROUND OF THE INVENTION

It is common for a website to allocate display space for paid advertisements (ads) as a means of generating revenue. However, because the number of ads available for display can significantly exceed the number of advertisement (ad) spaces available, it is necessary to select a particular set of ads for display. In general, when a displayed ad is clicked-on by a user, an owner of the clicked-on ad is charged a fee for having the corresponding ad displayed. Therefore, because a given ad generates revenue when it is clicked-on by a user, it is preferable to select ads for display that have a higher likelihood of being clicked-on.

When a new ad is introduced, there is no way of knowing whether the new ad will succeed in generating revenue, i.e., in being clicked on. Also, there is a chance that previously existing ads, i.e., proven ads, will be continuously selected to occupy all of the available ad spaces, thereby effectively blocking the new ad from being displayed, and in turn denying the new ad an opportunity to demonstrate its worth. It is necessary that new ads be given an opportunity to be displayed. However, a difficulty exists in that the display of new ads should be done in a manner that preserves the revenue generation derived from the display of proven ads.

### SUMMARY OF THE INVENTION

In one embodiment, a computer implemented method for advertisement display policy exploration is disclosed. The method includes an operation for generating an exploratory ordering of advertisements using an exploration policy. The exploration policy is a modified version of an existing policy. The exploration policy is defined to swap a pair of adjacent advertisements in an ordering of advertisements generated by the existing policy, so as to generate the exploratory ordering of advertisements. An operation is also performed to display a top number of the exploratory ordering of advertisements, wherein the top number corresponds to a number of available advertisement display spaces. The method also includes an operation for collecting click data associated with display of the exploratory ordering of advertisements. The method further includes an operation for evaluating a revenue generation capability of a new policy based on the collected click data.

In another embodiment, a computer implemented method for exploring revenue generation capability of non-experienced advertisements is disclosed. The method includes an operation for generating a slate of advertisements for display through application of a policy to a current context. The method also includes an operation for selecting a test advertisement for substitution into the generated slate of advertisements. The selected test advertisement is then substituted into the generated slate of advertisements. The method also includes an operation for recording a click performance of the substituted test advertisement. The method further includes an operation for adjusting a weighting of the substituted test advertisement based on the recorded click performance. The weighting of the substituted test advertisement influences a probability that the substituted test advertisement will be re-selected for substitution into another generated slate of advertisements.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 is an illustration showing a search page in which a slate of ads is displayed in conjunction with search results, in accordance with one embodiment of the present invention;

FIG. 2 is an illustration showing a flowchart of a method for advertisement display policy exploration, in accordance with one embodiment of the present invention; and

FIG. 3 is an illustration showing a flowchart of a method for exploring revenue generation capability of non-experienced advertisements, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

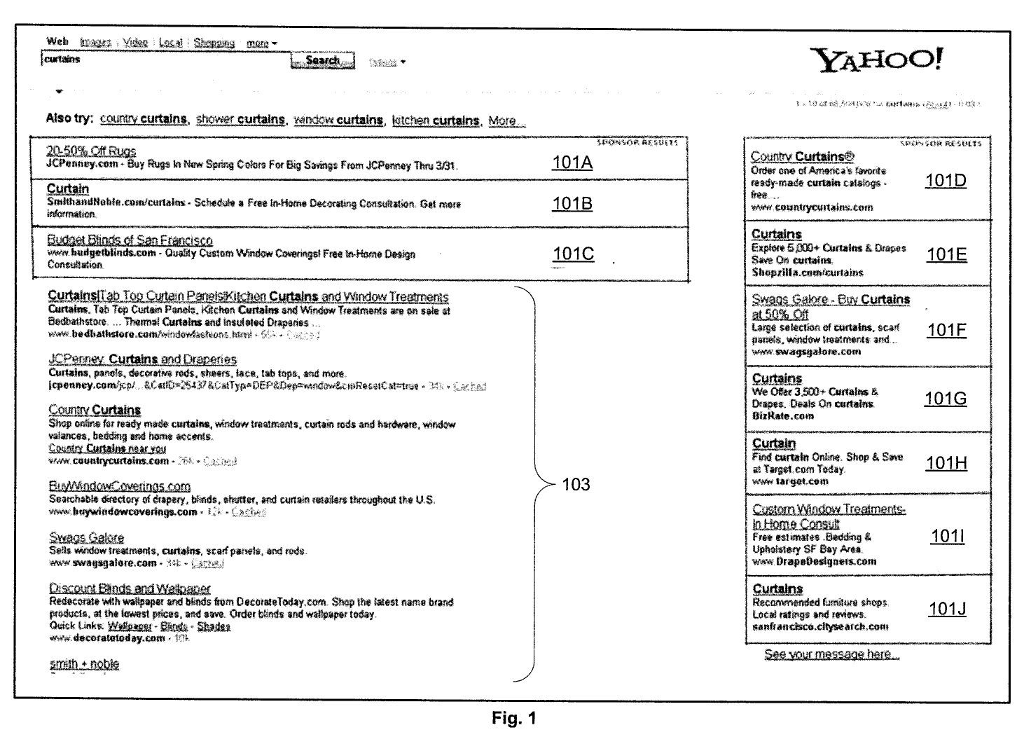

One technique for generating revenue through a webpage is to display advertisements (ads) within allocated spaces on the webpage and to charge an advertisement (ad) owner a fee whenever their ad is clicked-on by a user. For example, FIG. 1 is an illustration showing a search page in which a slate of ads is displayed in conjunction with search results 103, in accordance with one embodiment of the present invention. The sponsored ads which occupy the allocated spaces 101A through 101J in the search page of FIG. 1 define the slate of ads. Each ad in the slate of ads is selected from an available population of ads.

An objective in selecting the slate of ads is to select a slate of ads that will optimize revenue generation. Because revenue is generated by an ad when a user clicks on the ad, i.e., when a user selects the ad, a corresponding objective in selecting the slate of ads to display is to select ads that have a high likelihood of being clicked-on by a user. However, as discussed below, the revenue generation capability of a given ad is a function of both the likelihood of a user click on the given ad and a bid amount associated with the given ad, wherein the bid amount of the given ad represents a maximum fee that may be charged per click on the given ad. Therefore, to optimize revenue generation through the slate of ads, it is appropriate to select ads that are both likely to be clicked-on by a user in a given context, and that have a relatively high bid amount compared to other available ads. To this end, a method is disclosed herein for selecting a slate of ads to be displayed so as to optimize revenue generation. However, before delving into the method, a number of associated definitions and concepts are described.

An ad (a) is defined to have a content (c). The ad (a) is also defined to have a bid (b) that is linked to a budget (B). Therefore, the ad (a) can be represented as a=(b,B,c). Also, the bid of an ad (a) is referred to as bₐ.

A context (x) is defined generally as every bit of information which is available and helpful in predicting which ad to display. The context (x) may include (but is not limited to): 1) a query by a user, 2) past queries by the same user, 3) a content (c) of the available ads, 4) a location of the user, 5) past purchases by the user, 6) a time of day/week/month/year, and/or 7) a set of ads available. The context (x) may be represented in a number of forms. For example, the context (x) may be represented as a vector of bits which encode the context information. However, it should be understood that the methods described herein are equally applicable to any context (x), regardless of the form in which the context (x) is represented.

A policy (π) is defined as a function on the context (x) that orders ads. More specifically, the term πᵢ(x) represents the ad (aᵢ) that is placed by the policy (π) at the i-th position in the ordering of ads, when the policy (π) is applied to the context (x). In one embodiment, the policy (π) is also defined to determine how many ads are to be displayed. However, it should be understood that in other embodiments the policy (π) is not required to determine how many ads are to be displayed.

Each ad has an associated ad revenue (r) when clicked-on by a user. The ads are ordered a₁, . . . , aₙ, by the policy (π) applied to the context (x), with a revenue for the i-th ad of rᵢ(x,π) for clicking on ad (aᵢ). The revenue rᵢ(x,π) for clicking on ad (aᵢ) is upper bounded by the bid amount (bᵢ) for ad (aᵢ). Also, as described below in a method for pricing a user-selected ad, the revenue rᵢ(x,π) for clicking on ad (aᵢ) is a function of the other ads in the displayed slate of ads, and is not dependent on the bid amount (bᵢ) for ad (aᵢ), although it is capped by the bid amount (bᵢ) for ad (aᵢ).

In a process of selecting a slate of ads for display, a current context (x) is drawn from an unknown distribution D. The context (x) includes the set of available ads {a}, represented as Aₓ. A policy (π) is used to order the ads in Aₓ. The slate of ads to be displayed is selected from the beginning of the ordered ads in Aₓ. A set of user clicks (c₁, . . . , cₙ) are received. The set of user clicks (c₁, . . . , cₙ) respectively correspond to the ordered set of ads (a₁, . . . , aₙ). Also, the set of user clicks (c₁, . . . , cₙ) is drawn according to some unknown distribution (P|x, a₁, . . . , aₙ). Each user click variable (cᵢ) can have a state of 1 or 0, wherein the state of a user click variable (c₁) is 1 if the user clicks on the ad (aᵢ) at position (i) in the ordered set of ads (a₁, . . . , aₙ), and 0 otherwise. Because a limited number of ad spaces are available in a given display, i.e., in a given ad slate, only a limited number of ads at the beginning of the ordered set of ads (a₁, . . . , aₙ) will be displayed at a given time. The state of the user click variable (cᵢ) for each non-displayed ad is 0. The revenue generated by each ad in the displayed slate of ads equals rᵢ(x,π) if cᵢ=1, and equals 0 if cᵢ=0.

An expected revenue (ER_{π}) of a given policy (π) is represented as shown in Equation 1, wherein (E_{x˜D}) is an expectation that a given context (x) is drawn from some distribution D, wherein P(cᵢ=1|x,a₁, . . . ,aₙ) is a probability that a given ad (aᵢ) is clicked by a user in the given context (x), and wherein rᵢ(x,π) is a revenue generated by the given ad (aᵢ) when clicked on in the displayed slate of ads as ordered by the policy (π) operating on the given context (x). It is desirable to maximize the expected revenue (ER_{π}). Therefore, an objective is to optimize a policy (π) that will maximize the expected revenue (ER_{π}).

$${ER}_{π} = {\sum }_{i = 1}^{n} {E}_{x ∼ D} P ( {c}_{i} = 1 \vert x , {a}_{1} , … , {a}_{n} ) {r}_{i} ( x , π ) . \qquad Equation 1$$

Due to the difficulty associated with directly estimating the click-through-rate (CTR) probability for a given ad, particularly when the CTR probability is context dependent and ad display position dependent, it is of interest to have a method for optimizing the policy (π) so as to maximize the expected revenue (ER_{π}) without requiring a direct, i.e., explicit, evaluation of a policy (π). To this end, methods are disclosed herein to enable optimization of an ad ranking/pricing policy (π), with regard to revenue generation, without requiring explicit evaluation of a policy (π).

A first consideration in separating CTR probability estimation from policy (π) optimization is economics. Each policy (π) has an associated implicit generalized second price auction. The implicit generalized second price auction is defined as follows. For application of an arbitrary policy (π) to a given context (x) so as to place an ad (aᵢ) in the i-th position, a financial reward is determined for a click on the ad (aᵢ). First, the bid (bᵢ) of ad (aᵢ) is altered to a bid (bᵢ′), thereby defining a perturbation of the context (x), which is represented as z(x,a,bᵢ′). For example, if x={u,{a}}, where (u) denotes other context, and {a=(b,B,c)} is a set of ads, then x_{a′b′}{u,{a}}, where a′=(b′,B,c) for the ad aᵢ=a′. In other words, the context (x_{a′b′}) is the same as the context (x) except that the bid of ad (aᵢ) is changed from (bᵢ) to (bᵢ′). Second, the implicit generalized second price auction is defined by the relationship shown in Equation 2. In other words, the revenue (rᵢ) generated by a click on ad (aᵢ) is the value of the minimal bid for ad (aᵢ) that would maintain the ad (aᵢ) in the i-th position in the ad ordering as generated by applying the policy (π) to the context (x).

rᵢ(x,π)=min{b:πᵢ(xₐ_{ᵢ}_{b})=aᵢ} Equation 2.

To maintain incentive compatibility in the case of a single ad to be displayed, it is stipulated that the “winning” ad be monotonic with respect to the bid of the “winning” ad. In other words, if πᵢ(x)=aᵢ, it is required that for all bids b′>bₐᵢ, either πᵢ(x_{aib′})=aᵢ, or πⱼ(x_{aib′})=aᵢ for j<i. Restated, in an implicit generalized second price auction, the smallest possible bid (bᵢ) for a click on ad (aᵢ) is charged such that the ad (aᵢ) can maintain its position (i) under the policy (π) as applied to the context (x), when all other variables except for the bid (bᵢ) are held constant in the context (x). The implicit generalized second price auction ensures that the payoff (rᵢ) for the click on ad (aᵢ) does not depend on the actual bid (bᵢ), and that the payoff (rᵢ) is no larger than the actual bid (bᵢ). Also, when only one ad is displayed, the implicit generalized second price auction is incentive compatible.

To facilitate optimization of a policy to maximize revenue, a parameterized policy π_{θ}(x) is defined to include a tuning parameter θ. The expected revenue (ER_{πθ}) for the parameterized policy is shown in Equation 3. In order to find the parameter θ to optimize the total revenue (ER_{πθ}), it is only necessary to have a good estimate of the position/context/user dependent CTR probability P(cᵢ=1|x,a₁, . . . ,aₙ) for each position (i) and context (x, a₁, . . . , aₙ).

$${ER}_{π θ} = {\sum }_{i = 1}^{n} {E}_{x ∼ D} P ( {c}_{i} = 1 \vert x , {a}_{1} , … , {a}_{n} ) {r}_{i} ( x , {π}_{θ} ) . \qquad Equation 3$$

CTR prediction can be performed using counting-based techniques or machine learning-based techniques. When the amount of data is very large, and the context is small, the CTR probability may be estimated using the relative counts of events, such as shown in Equation 4. However, estimating CTR probability based on the relative counts of events breaks down quickly as the context (x) size increases. One approach for extending the ability to estimate the CTR probability based on the relative counts of events is to omit some context. For example, conditioning the CTR probability on just (x,aᵢ,i) may extend the ability to estimate the CTR probability based on the relative counts of events. However, when the context becomes sufficiently large, machine learning-based techniques are needed to estimate the CTR probability.

$$\hat{P} ( {c}_{i} = 1 \vert x , {a}_{1} , … , {a}_{n} ) = \frac{\vert \{ events with context ( x , {a}_{1} , … , {a}_{n} ) and click {c}_{i} \} \vert}{\{ events with context ( x , {a}_{1} , … , {a}_{n} ) \}} . \qquad Equation 4$$

Machine learning is a way of using past observations to predict future behavior. For example, a given ad may have been previously displayed in a particular context, and the given ad was either clicked or not. This data about the previously displayed ad can be used to predict whether a similar future ad in a similar future context will be clicked or not. In one embodiment, machine learning-based techniques for estimating the CTR probability utilize a proper scoring function defined as a loss function for which an optimizer of the loss is the probability of an event. Two types of proper scoring functions include log loss and squared loss. In one embodiment, a CTR predictor is found by creating examples ((x,i),cᵢ), and then optimizing the prediction of squared loss over some architecture. Given CTR estimates, a policy (π) is learned by optimizing Equation 3 over θ. In a custom learning algorithm, Equation 3 may be optimized by a straightforward gradient descent application.

In one embodiment, a new policy (π′) created after estimating CTR is different from the policy (π) which was used to collect data for the CTR estimate. Therefore, in this embodiment, the “test data” for the CTR predictor is drawn from a different distribution than the “training data.” In one embodiment, the difference between “test data” and “training data” is dealt with by constraining the optimization over the new policy (π′) so that it cannot differ greatly from the policy (π) used to generate the samples for the CTR predictor. In one embodiment, an iterative process for policy (π) optimization to maximize revenue includes:
(1) Use policy (π) to gather data,
(2) Use machine learning (or simple counting) to predict CTR, and
(3) Learn a new policy (π′) which replaces (π).

An inherent difficulty in policy learning, is that the new policy (π′) includes a bias that results from the previous policy's (π) influence on the data collected. For example, if a previous policy (π) chooses to not display an ad (aᵢ) in some context (x), then the information needed to decide whether of not the ad (aᵢ) is good in the context (x) is missing. Methods are described below for counteracting such bias in policy learning. In particular, a method is disclosed for systematically exploring ad-context pairs. More specifically, when data is gathered, the method uses small deviations from the current policy (π) to explore likely alternative ads of potentially good quality. Then, when learning a new policy (π′) on this gathered data, the set of possible explorations and their probability or frequency is explicitly taken into account in order to learn the new policy (π′). This method functions to yield a better ad placement policy so as to improve revenue and relevance of displayed ads.

In one embodiment, a new policy is learned by reordering ads in an ad sequence generated by an existing policy. Consider that (π_{ctr}) represents an existing policy learned via earlier techniques. Then, consider that (π′(x,π_{ctr}(x)) represents a randomized policy that sometimes swaps an adjacent pair of ads in an ad sequence generated by the existing policy (π_{ctr}), when applied to context (x). Click data associated with display of the ad sequence as modified by the randomized policy (π′(x,π_{ctr}(x)) is collected. From this collected click data, a new policy (π(x,π_{ctr}(x))) is learned, which swaps up to one pair of adjacent ads. An expected revenue (ER_{π}) for the new policy is shown in Equation 5.

$${ER}_{π} = {E}_{x ∼ D} {\sum }_{i = 1}^{n} {r}_{i} ( x , π ) {E}_{{c}_{i} , {π}^{′} ( x ) \vert x} \frac{{c}_{i} I ( {π}^{′} ( x , {π}_{ctr} ( x ) ) = π ( x , {π}_{ctr} ( x ) ) )}{Pr ( {π}^{′} ( x , {π}_{ctr} ( x ) ) = π ( x , {π}_{ctr} ( x ) ) \vert x )} . \qquad Equation 5$$

In Equation 5, the term E_{ci,π′(x)|x} represents an expectation over decisions made by an exploration policy (π′) and click outcomes for the displayed ad, conditioned on context features. The term (cᵢ) represents whether (and which) ads are clicked on in the i-th display event. The term I(π′(x,π_{ctr}(x))=π(x,π_{ctr}(x))) represents the value 1 if the exploration policy (π′) chooses the same action as the policy (π), and 0 otherwise. The term Pr(π′(x,π_{ctr}(x))=π(x,π_{ctr}(x))|x) represents the probability that the exploration policy (π′) chooses the same action as the evaluated policy (π). If a new policy is sought by making small modifications to an existing policy, such as randomly swapping an adjacent pair of ads, then the term Pr(π′(x,π_{ctr}(x))=π(x,π_{ctr}(x))|x) can be reasonably large.

It should be understood that the method of randomly swapping an adjacent pair of ads in a policy-generated ad sequence, as a means for exploring a new policy, is provided by way of example. In other words, exploration of new policies for ordering of ads to optimize revenue generation can be performed in many different ways. However, it should be noted that exploration of a new policy based on a minor modification of an existing policy allows the exploration to be constrained over a manageable parameter space, such that a performance (with respect to revenue generation) of the new policy can be meaningfully evaluated against a performance of the existing policy. If the new policy is determined to provide better revenue generation performance than the existing policy, then the existing policy is replaced by the new policy, and the “incremental” exploration continues based on the ad ordering as generated by the new policy.

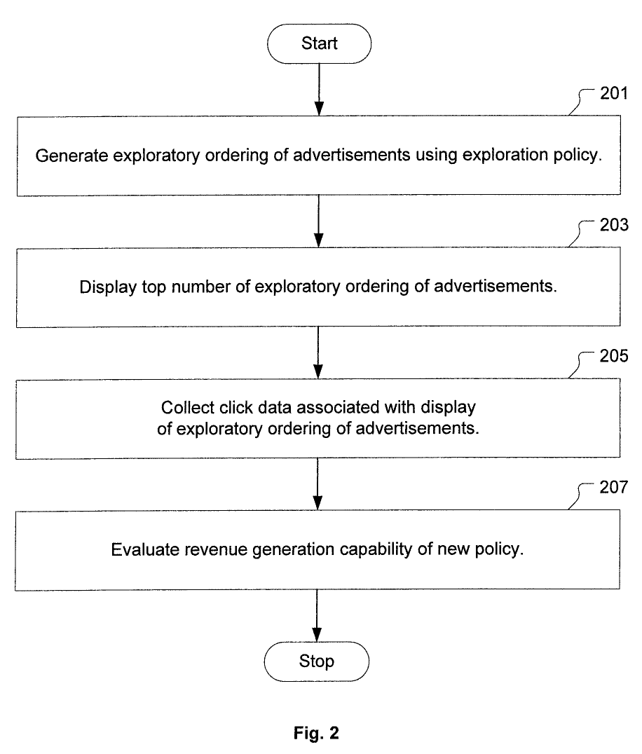

FIG. 2 is an illustration showing a flowchart of a method for advertisement display policy exploration, in accordance with one embodiment of the present invention. It should be understood that the operations of the method of FIG. 2 can be implemented by a computer operating in accordance with set of suitably defined instructions. The method includes an operation 201 for generating an exploratory ordering of advertisements using an exploration policy. The exploration policy is a modified version of an existing policy. More specifically, the exploration policy is defined to swap a pair of adjacent advertisements in an ordering of advertisements generated by the existing policy, so to generate the exploratory ordering of advertisements. In one embodiment, the pair of adjacent advertisements swapped by the exploration policy is randomly selected within a top number of the ordering of advertisements generated by the existing policy. The top number of the ordering of advertisements corresponds to a number of available advertisement display spaces.

In the method of FIG. 2, each of the exploration policy and the existing policy represents a policy that operates to generate a slate of advertisements for display from a population of advertisements. Each advertisement in the population of advertisements has an associated revenue value defined by a bid amount of the advertisement and a relevance of the advertisement to a context. The context is a set of available information to be operated on by the policy to generate the slate of advertisements for display. In one embodiment, the context includes one or more of a current query by a current user, a number of past queries by the current user, a content of each advertisement in the population of available advertisements, a location of the current user, past actions by the current user, and/or a current time.

The method continues with an operation 203 for displaying a top number of the exploratory ordering of advertisements. The top number corresponds to a number of available advertisement display spaces. The method further includes an operation 205 for collecting click data associated with display of the exploratory ordering of advertisements. Then, based on the collected click data, an operation 207 is performed to evaluate a revenue generation capability of a new policy. In one embodiment, the method includes an operation for comparing the revenue generation capability of the exploration policy to a revenue generation capability of the existing policy. If the revenue generation capability of the exploration policy is greater than the revenue generation capability of the existing policy, the existing policy is replaced by the exploration policy.

When a new advertisement is inserted into the population of available advertisements, there is little to no information available as whether or not the new advertisement is capable of generating revenue. Therefore, it is desirable to have the new advertisement inserted into a displayed slate of advertisements in an exploratory manner to gather some data as to whether or not the new advertisement is capable of generating revenue. However, insertion of a new advertisement should be done in a manner that takes into account a probability that the particular new advertisement is inserted. For example, an advertisement that is inserted once and gets clicked on once should not necessarily be treated in the same manner as an advertisement that gets inserted multiple times and gets clicked on once.

A technique is disclosed herein for weighting each test advertisement (i.e., a new advertisement that is being explored) by an inverse of a probability that the test advertisement is inserted for exploration. In other words, the weighting of a given test advertisement is equal to [1/(probability that the given test advertisement is inserted)]. When a test advertisement is inserted, a “click performance” of the test advertisement is adjusted by the weighting of the test advertisement. In one embodiment, the “click performance” of the test advertisement for a given insertion instance, prior to weighting, evaluates to 1 if the test ad is clicked on, and 0 otherwise.

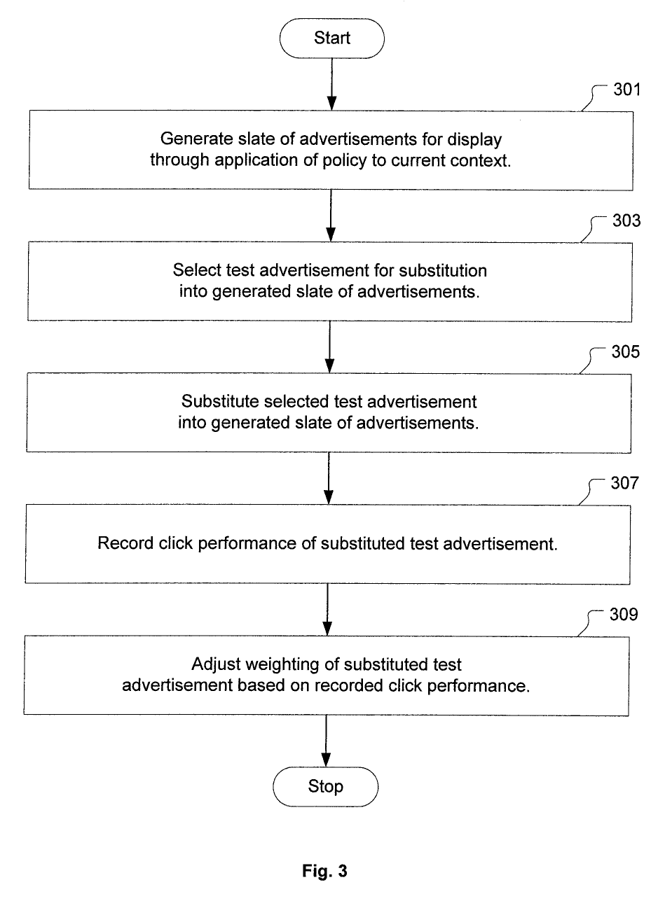

FIG. 3 is an illustration showing a flowchart of a method for exploring revenue generation capability of non-experienced advertisements, in accordance with one embodiment of the present invention. It should be understood that the operations of the method of FIG. 3 can be implemented by a computer operating in accordance with set of suitably defined instructions. The method includes an operation 301 for generating a slate of advertisements for display through application of a policy to a current context. In this embodiment, the policy is defined to generate the slate of advertisements from a population of advertisements. Each advertisement in the population of advertisements has an associated revenue value defined by a bid amount of the advertisement and a relevance of the advertisement to a context. The context is a set of available information to be operated on by the policy to generate the slate of advertisements. In one embodiment, the context includes one or more of a current query by a current user, a number of past queries by the current user, a content of each advertisement in the population of available advertisements, a location of the current user, past actions by the current user, and/or a current time.

The method also includes an operation 303 for selecting a test advertisement for substitution into the generated slate of advertisements. The test advertisement is selected from a set of test advertisements. The set of test advertisements includes test advertisements that are related to the current context and that have insufficient click performance data within the current context. In one embodiment, a probability distribution of selection is applied over the test advertisements in the set of test advertisements. In this embodiment, the test advertisement substituted into the generated slate of advertisements is selected based on the applied probability distribution of selection. In one version of this embodiment, the probability distribution of selection is a flat distribution, such that each test advertisement has an equal probability of being selected for substitution into the generated slate of advertisements for display. In another version of this embodiment, the probability distribution of selection is a distribution weighted by a relevance of each test advertisement to the current context, such that test advertisements that are more relevant to the current context have a higher likelihood of being selected for substitution into the generated slate of advertisements for display.

The method further includes an operation 305 for substituting the selected test advertisement into the generated slate of advertisements. In one embodiment, the selected test advertisement is substituted into the generated slate of advertisements at a random advertisement display location. In another embodiment, the selected test advertisement is substituted into the generated slate of advertisements at a high-performance advertisement display location, i.e., at an advertisement display location that has a demonstrated high click rate. The method also includes an operation 307 for recording a click performance of the substituted test advertisement.

In an operation 309, a weighting of the substituted test advertisement is adjusted based on the recorded click performance. The weighting of the substituted test advertisement influences a probability that the substituted test advertisement will be re-selected for substitution into another generated slate of advertisements. In one embodiment, upon a click on the substituted test advertisement, a revenue amount generated by the test advertisement is multiplicatively adjusted by an inverse of a probability that the substituted test advertisement was selected for substitution into the generated slate of advertisements. Therefore, the revenue generated by a test advertisement is exaggerated for the purpose of promoting advancement of the test advertisement within the general population of advertisements.

In one embodiment, the method of FIG. 3 for exploring revenue generation capability of non-experienced advertisements is performed such that substitution of test advertisements into the displayed slate of advertisements does not significantly and adversely impact the revenue generation capability of the displayed slate of advertisements. For example, substitution of test advertisements into generated slates of advertisements for display can be done at frequency which optimizes data acquisition for test advertisements without significantly impacting revenue generation. The method of FIG. 3 can also be defined to promote successful test advertisements, as based on revenue generation, from the set of test advertisements to the general population of advertisements. For example, in one embodiment, when a given test advertisement is clicked on, a weighting of the given test advertisement can be adjusted upward relative to the weightings of the other advertisements in the set of test advertisements. Then, when the weight of a given test advertisement exceeds a threshold value, the test advertisement can be promoted to the general population of advertisements.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A computer implemented method for advertisement display policy exploration, comprising:
generating an exploratory ordering of advertisements using an exploration policy, wherein the exploration policy is a modified version of an existing policy, the exploration policy defined to swap a pair of adjacent advertisements in an ordering of advertisements generated by the existing policy to generate the exploratory ordering of advertisements;
displaying a top number of the exploratory ordering of advertisements, wherein the top number corresponds to a number of available advertisement display spaces;
collecting click data associated with display of the exploratory ordering of advertisements; and
evaluating a revenue generation capability of a new policy based on the collected click data.

2. A computer implemented method for advertisement display policy exploration as recited in claim 1, further comprising:
comparing the revenue generation capability of the exploration policy to a revenue generation capability of the existing policy; and
replacing the existing policy with the exploration policy when the revenue generation capability of the exploration policy is greater than the revenue generation capability of the existing policy.

3. A computer implemented method for advertisement display policy exploration as recited in claim 1, wherein the pair of adjacent advertisements swapped by the exploration policy is randomly selected within the top number of the ordering of advertisements generated by the existing policy.

4. A computer implemented method for advertisement display policy exploration as recited in claim 1, wherein each of the exploration policy, the existing policy, and the new policy represents a policy that operates to generate a slate of advertisements for display from a population of advertisements, wherein each advertisement in the population of advertisements has an associated revenue value defined by a bid amount of the advertisement and a relevance of the advertisement to a context.

5. A computer implemented method for advertisement display policy exploration as recited in claim 4, wherein the context is a set of available information to be operated on by the policy to generate the slate of advertisements for display.

6. A computer implemented method for advertisement display policy exploration as recited in claim 5, wherein the context includes one or more of a current query by a current user, a number of past queries by the current user, a content of each advertisement in the population of available advertisements, a location of the current user, past actions by the current user, a current time.

7. A computer implemented method for exploring revenue generation capability of non-experienced advertisements, comprising:
generating a slate of advertisements for display through application of a policy to a current context;
selecting a test advertisement for substitution into the generated slate of advertisements;
substituting the selected test advertisement into the generated slate of advertisements;
recording a click performance of the substituted test advertisement; and
adjusting a weighting of the substituted test advertisement based on the recorded click performance, wherein the weighting influences a probability that the substituted test advertisement will be re-selected for substitution into another generated slate of advertisements.

8. A computer implemented method for exploring revenue generation capability of non-experienced advertisements as recited in claim 7, wherein the policy is defined to generate the slate of advertisements from a population of advertisements, wherein each advertisement in the population of advertisements has an associated revenue value defined by a bid amount of the advertisement and a relevance of the advertisement to the current context.

9. A computer implemented method for exploring revenue generation capability of non-experienced advertisements as recited in claim 8, wherein the current context is a set of available information to be operated on by the policy to generate the slate of advertisements.

10. A computer implemented method for exploring revenue generation capability of non-experienced advertisements as recited in claim 9, wherein the current context includes one or more of a current query by a current user, a number of past queries by the current user, a content of each advertisement in the population of available advertisements, a location of the current user, past actions by the current user, a current time.

11. A computer implemented method for exploring revenue generation capability of non-experienced advertisements as recited in claim 7, wherein the test advertisement is selected from a set of test advertisements, and wherein the set of test advertisements includes test advertisements that are related to the current context and that have insufficient click performance data within the current context.

12. A computer implemented method for exploring revenue generation capability of non-experienced advertisements as recited in claim 11, further comprising:
applying a probability distribution of selection over the test advertisements in the set of test advertisements; and
selecting the test advertisement for substitution into the generated slate of advertisements based on the applied probability distribution of selection.

13. A computer implemented method for exploring revenue generation capability of non-experienced advertisements as recited in claim 12, wherein the probability distribution of selection is a flat distribution such that each test advertisement has an equal probability of being selected for substitution into the generated slate of advertisements for display.

14. A computer implemented method for exploring revenue generation capability of non-experienced advertisements as recited in claim 12, wherein the probability distribution of selection is a distribution weighted by a relevance of each test advertisement to the current context, such that test advertisements that are more relevant to the current context have a higher likelihood of being selected for substitution into the generated slate of advertisements for display.

15. A computer implemented method for exploring revenue generation capability of non-experienced advertisements as recited in claim 7, wherein the selected test advertisement is substituted into the generated slate of advertisements at a random advertisement display location.

16. A computer implemented method for exploring revenue generation capability of non-experienced advertisements as recited in claim 7, wherein the selected test advertisement is substituted into the generated slate of advertisements at a high-performance advertisement display location.

17. A computer implemented method for exploring revenue generation capability of non-experienced advertisements as recited in claim 7, wherein upon a click on the substituted test advertisement, the weighting of the substituted test advertisement is adjusted multiplicatively by an inverse of a probability that the substituted test advertisement was selected for substitution into the generated slate of advertisements.
